(19) United States
(12) Patent Application Publication
(10) Pub. No.: US 2026/0348357 A1
(43) Pub. Date: Nov. 5, 2026

(54) METHOD OF WAKE STEERING WIND TURBINE

(71) Applicant: VESTAS WIND SYSTEMS A/S, Aarhus N (DK)

(72) Inventors: Mark FABER, Risskov (DK); Mahmood MIRZAEI, Skovlunde (DK); Poul Brandt CHRISTENSEN, Ry (DK); Fabio SPAGNOLO, Aarhus C (DK); Andreas Skov JENSEN, Skanderborg (DK)

(21) Appl. No.: 19/486,838

(22) PCT Filed: May 22, 2024
(86) PCT No.: PCT/DK2024/050120

§ 371 Date: Nov. 21, 2025

(30) Foreign Application Priority Data
May 23, 2023 (DK) PA202370246

(51) Int. Cl. F03D 7/02; F03D 7/04

(52) U.S. Cl. CPC F03D 7/0204; F03D 7/0224; F03D 7/049; F05B 2270/204

(57) ABSTRACT

The invention pertains to wake steering. A second wind turbine is positioned downstream of the first wind turbine so that it can be affected by a wake of the first wind turbine. In a method of the invention, a yaw offset signal is applied to create a yaw offset between a rotor of the first wind turbine and the wind direction, and the yaw offset signal is varied based on a transfer function in response to changes in the wind direction. The transfer function comprises: a negative offset band, a negative transition, a positive offset band, a positive transition, and a dead band between the positive and negative transitions.

### FIELD OF THE INVENTION

The present invention relates to a method of wake steering a wind turbine, a yaw offset controller configured to control a wind turbine by such a method; and a wind turbine comprising such a yaw offset controller.

### BACKGROUND OF THE INVENTION

A known method of controlling a first wind turbine of a plurality of wind turbines of a wind park is disclosed in US2021/207580 A1. A second wind turbine of the plurality of wind turbines can be affected by a wake region caused by the first wind turbine which is positioned upstream of the second wind turbine. The method comprises: determining a current yaw state; determining a wind condition indicative of a level of potential wake inducement at the second wind turbine caused at least by the first wind turbine; and defining a rotor yaw offset angle set point for the first wind turbine based on the current yaw state, the wind condition, and at least one yaw angle hysteresis switching threshold. The rotor yaw offset angle set point follows a hysteresis, thereby avoiding immediate consecutive switching between a range of positive yaw offset angles and negative yaw offset angles.

### SUMMARY OF THE INVENTION

A first aspect of the invention provides a method of wake steering a first wind turbine, wherein a second wind turbine is positioned downstream of the first wind turbine so that the second wind turbine can be affected by a wake of the first wind turbine, the method comprising: applying a yaw offset signal to a yaw control system of the first wind turbine, the yaw offset signal causing the yaw control system to create a yaw offset between a rotor of the first wind turbine and a wind direction, the yaw offset steering the wake away from the second wind turbine; and varying the yaw offset signal in response to changes in the wind direction, wherein the yaw offset signal is varied on the basis of a transfer function, and the transfer function comprises: a negative offset band in which the yaw offset signal is negative, and decreases to a minimum; a negative transition in which the yaw offset signal increases from the minimum; a positive offset band in which the yaw offset signal is positive, and increases to a maximum; a positive transition in which the yaw offset signal decreases from the maximum; and a dead band between the positive and negative transitions, the yaw offset signal being substantially zero in at least part of the dead band, so that in at least part of the dead band there is substantially zero offset between the rotor of the first wind turbine and the wind direction.

Optionally a rate of change of the transfer function decreases at a lower boundary of the dead band and increases at an upper boundary of the dead band.

Optionally the transfer function has a rate of change which is greater in the transitions than in the dead band.

Optionally the transfer function has a rate of change which is substantially zero in at least part of the dead band.

Optionally the transfer function has a rate of change which is substantially zero throughout the dead band.

Optionally each transition comprises a transition band which spans a range of wind directions.

Optionally the yaw offset signal is substantially zero throughout the dead band, so that throughout the dead band there is substantially zero offset between the rotor of the first wind turbine and the wind direction.

Optionally the yaw offset signal is lower than the maximum throughout the dead band and higher than the minimum throughout the dead band.

Optionally the method further comprises monitoring a wind variability condition and varying a width of the dead band on a basis of the wind variability condition.

Optionally the wake affects the second wind turbine when the first wind turbine is operating in the dead band.

Optionally the dead band straddles a full-wake wind direction, wherein the full-wake wind direction is parallel with a heading between the first and second wind turbines.

Optionally the dead band straddles the full-wake direction asymmetrically, with a range of the dead band being larger on one side of the full-wake direction than on the other side of the full-wake direction.

Optionally the method further comprises applying induction control to the first wind turbine in response to the wind turbine entering the dead band, wherein applying the induction control causes the wake to reduce.

Optionally applying the induction control comprises changing at least one of a pitch angle of one or more blades of the rotor and the tip speed ratio. Induction control may be performed by using a combination of adjusting the pitch angle and the tip speed ratio to reach a minimum thrust coefficient (Ct) while reducing the impact on the power coefficient (Cp).

Optionally the transfer function further comprises: a negative cut-out band between the negative offset band and the negative transition, wherein the yaw offset signal is substantially equal to the minimum throughout the negative offset cut-out band; and a positive cut-out band between the positive offset band and the positive transition, wherein the yaw offset signal is substantially equal to the maximum throughout the positive cut-out band.

A further aspect of the invention provides a yaw offset controller configured to control a first wind turbine by a method according to the first aspect.

A further aspect of the invention provides a wind turbine comprising: a rotor; a yaw control system; and a yaw offset controller according to the preceding aspect.

### BRIEF DESCRIPTION OF THE DRAWINGS

Embodiments of the invention will now be described with reference to the accompanying drawings, in which:

FIG. 1 shows a wind turbine.

FIG. 2A shows a control system of the wind turbine;

FIG. 2B shows various elements of the yaw offset controller;

FIG. 3 shows a transfer function not according to the present invention;

FIG. 4 shows an operating state at a first point of the transfer function;

FIG. 5 indicates a second point of the transfer function;

FIG. 6 shows an operating state at the second point;

FIG. 7 indicates a third point of the transfer function;

FIG. 8 shows an operating state at the third point;

FIG. 9 indicates a fourth point of the transfer function;

FIG. 10 shows an operating state at the fourth point;

FIG. 11 shows a transfer function according to a first embodiment of the present invention;

FIG. 12 indicates a first point of the transfer function of FIG. 11;

FIG. 13 shows an operating state at the first point of FIG. 12;

FIG. 14 indicates a second point of the transfer function of FIG. 11;

FIG. 15 shows an operating state at the second point of FIG. 14;

FIG. 16 indicates a third point of the transfer function of FIG. 11, at a full-wake wind direction;

FIG. 17 shows an operating state at the third point of FIG. 16;

FIG. 18 indicates a fourth point of the transfer function of FIG. 11;

FIG. 19 shows an operating state at the fourth point of FIG. 18;

FIG. 20 indicates a fifth point of the transfer function of FIG. 11;

FIG. 21 shows an operating state at the fifth point of FIG. 20;

FIG. 22 shows a transfer function according to a second embodiment of the present invention;

FIG. 23 shows a transfer function according to a third embodiment of the present invention;

FIG. 24 shows a transfer function according to a fourth embodiment of the present invention;

FIG. 25 shows a transfer function not according to the present invention, with a range of operating states; and

FIG. 26 shows a transfer function according to the present invention, with a range of operating states.

### DETAILED DESCRIPTION OF EMBODIMENT(S)

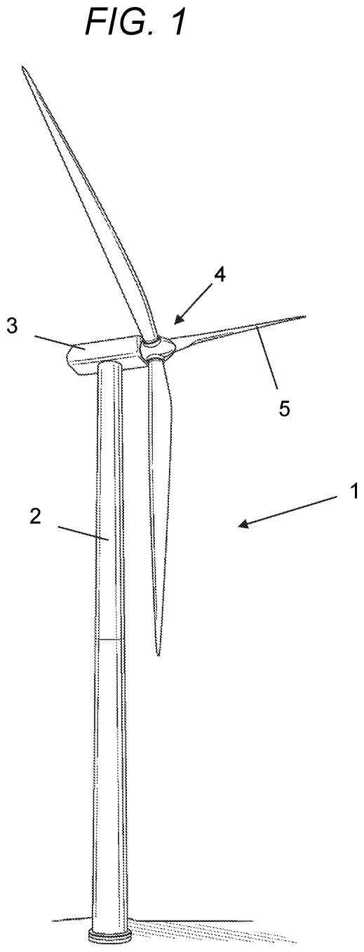

FIG. 1 illustrates, in a schematic perspective view, a first wind turbine 1. The wind turbine 1 includes a tower 2 and a rotor-nacelle assembly (RNA) at the top of the tower 2. The RNA includes a nacelle 3 and a rotor 4 operatively coupled to a generator housed inside the nacelle 3. In addition to the generator, the nacelle 3 houses various components required for converting wind energy into electrical energy and various components needed to operate and control the wind turbine 1.

The rotor 4 includes a central hub and a plurality of blades 5 that project outwardly from the central hub. In the illustrated wind turbine 1, the rotor 4 includes three blades 5, but the number may vary.

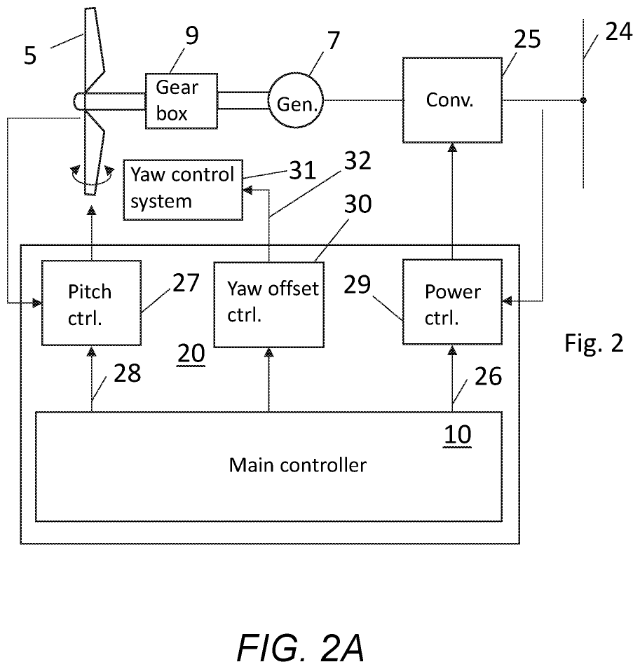

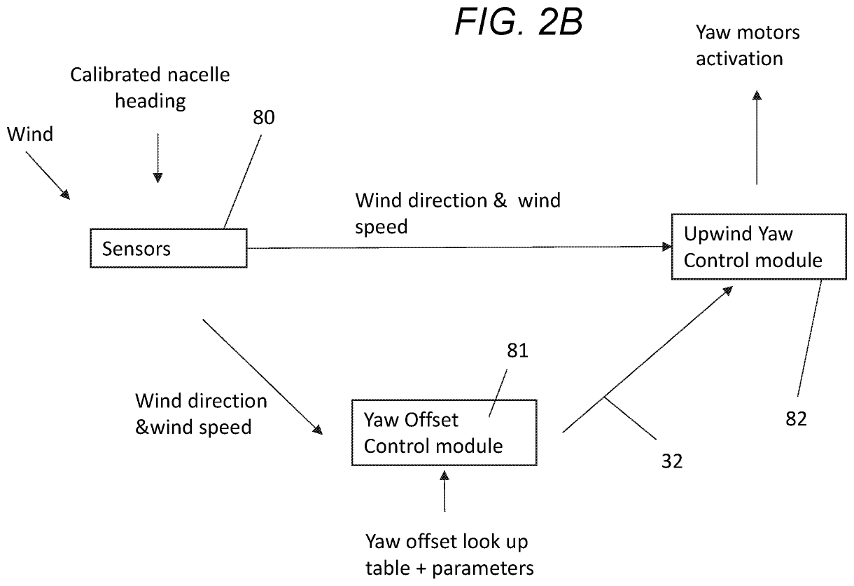

FIG. 2A schematically illustrates an embodiment of a control system 20 together with elements of the wind turbine 1. The rotor is mechanically connected to an electrical generator 7 via a gearbox 9 (in direct drive systems the gear box is not present). The electrical power generated by the generator 7 is injected into a power grid 24 via an electrical converter 25. The electrical generator 7 and the converter 25 may be based on a full scale converter (FSC) architecture or a doubly fed induction generator (DFIG) architecture, but other types may be used

The control system 20 comprises a number of elements, including at least one main controller 10 with a processor and a memory, so that the processor is capable of executing computing tasks based on instructions stored in the memory. In general, the main controller 10 ensures that in operation the wind turbine generates a requested power output level. This is obtained by adjusting the pitch angle of the blades and/or the power extraction of the converter 25. To this end, the control system 20 comprises a pitch system including a pitch controller 27 using a pitch reference signal 28, and a power system including a power controller 29 using a power reference signal 26. The rotor blades 5 can be pitched by a pitch mechanism. The rotor comprises an individual pitch system which is capable of individual pitching of the rotor blades 5, and may comprise a common pitch system which adjusts all pitch angles on all rotor blades at the same time. The control system 20, or elements of the control system 20, may be connected to a power plant controller (not shown) or other control system to receive externally provided instructions.

The wind turbine 1 comprises a yaw control system 31 configured to rotate the RNA 3, 4 about a vertical yaw axis, in order to control a yaw angle of the rotor 4. The yaw control system 31 comprises various elements, including yaw motors. The control system 20 comprises a yaw offset controller 30 configured to generate a yaw offset signal 32 which is input to the yaw control system 31.

The yaw offset controller 30 is configured to control the wind turbine 1 by varying the yaw offset signal 32 in response to changes in the wind direction. The yaw offset signal 32 may be varied on the basis of a transfer function, which is stored in a memory of the yaw offset controller 30. Various possible transfer functions will explained in more detail below.

FIG. 2B gives a schematic overview of elements of the yaw offset controller 30 and part of the yaw control system 31. The yaw offset controller 30 comprises sensors and processing 80 and a yaw offset control module 81; and the yaw control system 31 comprises an upwind yaw control module 82.

The sensors 80 receive as inputs the wind and a calibrated nacelle heading; and output a wind direction and wind speed to the modules 81, 82.

The yaw offset control module 81 outputs the yaw offset signal 32 to the upwind yaw control module 82. The yaw offset signal 32 is based on the wind direction, and the transfer function mentioned above, which may be stored by the yaw offset module 81 in the form of a look up table, or in any other way.

The upwind yaw control module 82 outputs yaw motor activation signals to the yaw motors based on the yaw offset signal 32 (which gives a target yaw offset) and the wind direction and wind speed.

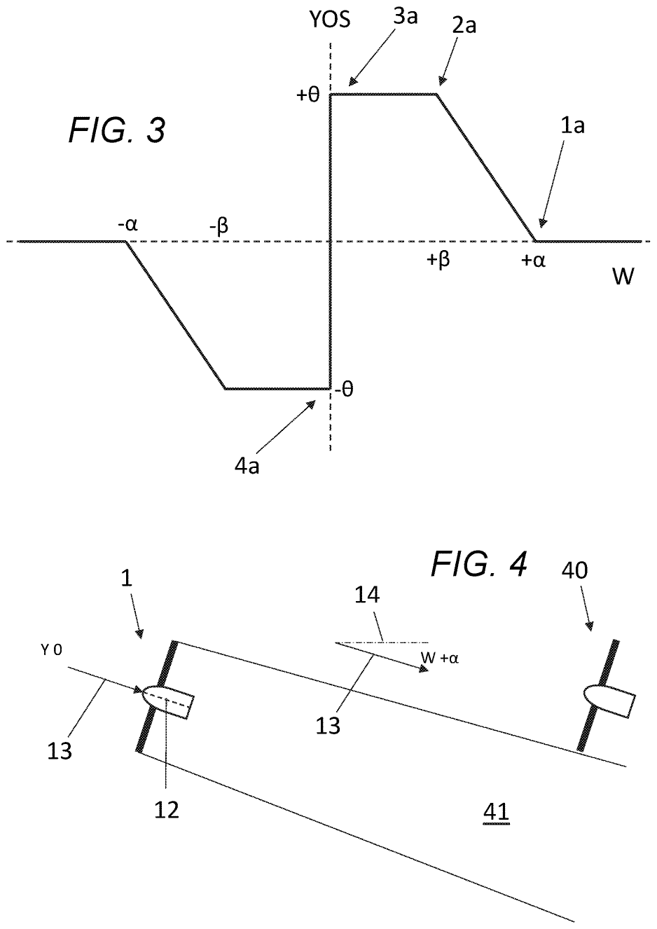

FIG. 3 gives a first example of a transfer function which may be used by the yaw offset controller 30. The transfer function of FIG. 3 is not according to the present invention and is described for reference purposes only.

As shown in FIG. 4, a second wind turbine 40 is positioned downstream of the first wind turbine 1 so that the second wind turbine 40 can be affected by a wake 41 of the first wind turbine 1. The direction between the turbines 1, 40 is indicated by a heading 14. When the wind 13 is parallel with the heading 14, the wind direction is referred to as a full-wake wind direction. The wind direction is generally referred to by W in FIGS. 3-26.

FIG. 4 shows the wind direction and yaw angles of the wind turbines 1, 40 at a first point 1a in the transfer function of FIG. 3. For this wind direction +a, the yaw offset signal 32 is set to zero so the rotor axis 12 is parallel to the wind 13. The wind direction +α is defined here as the angle of the wind 13 relative to the heading 14. In FIGS. 3-26 the yaw offset is generally referred to by Y, and the yaw offset is generally referred to by YOS.

Since the wind direction +α is a relatively large angle, the wake 41 does not significantly affect the second wind turbine 40 in the operating state of FIG. 4.

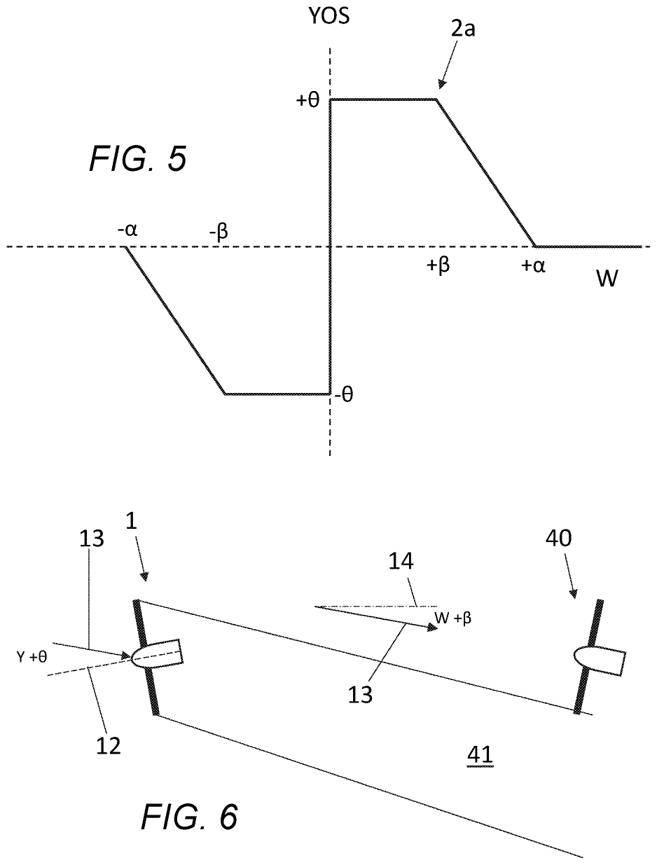

As the wind direction reduces from +α, thereby moving closer to the full-wake wind direction, the transfer function causes a progressively increasing yaw offset to be applied until it reaches a maximum at the point 2a shown in FIGS. 5 and 6. For this wind direction +β, the yaw offset signal 32 is at a maximum +θ so the rotor axis is at an angle +θ to the wind as shown in FIG. 6. As a result of the wake steering caused by the yaw offset, the wake 41 does not significantly affect the second wind turbine 40 in the operating state of FIG. 6.

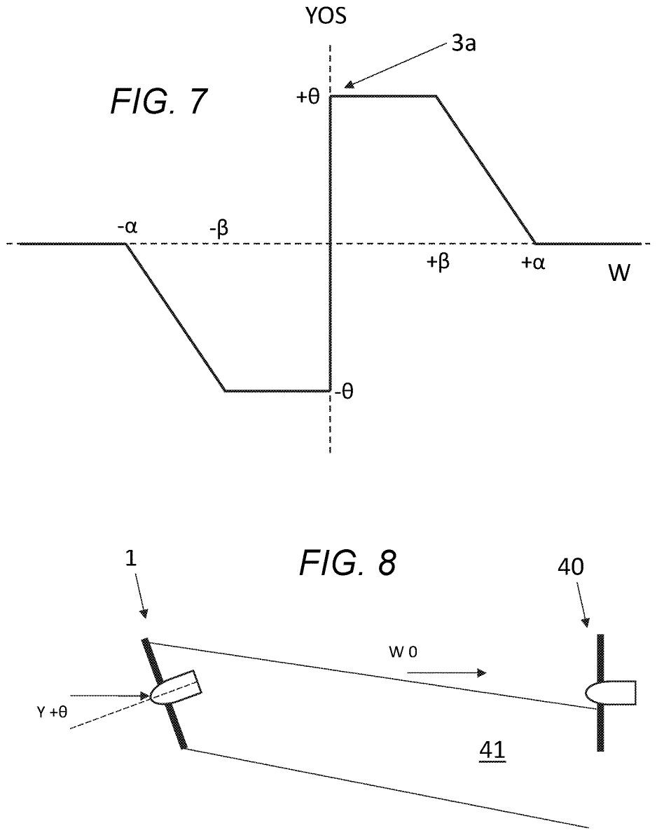

As the wind direction reduces from +β, the transfer function is flat until the point 3a shown in FIGS. 7 and 8 where the wind 13 is in the full-wake wind direction.

For this part of the transfer function the yaw offset signal 32 remains at the maximum +θ so the rotor axis remains at an angle +θ to the wind as shown in FIG. 8. At point 3a, the wake 41 may affect the second wind turbine 40 as shown in FIG. 8.

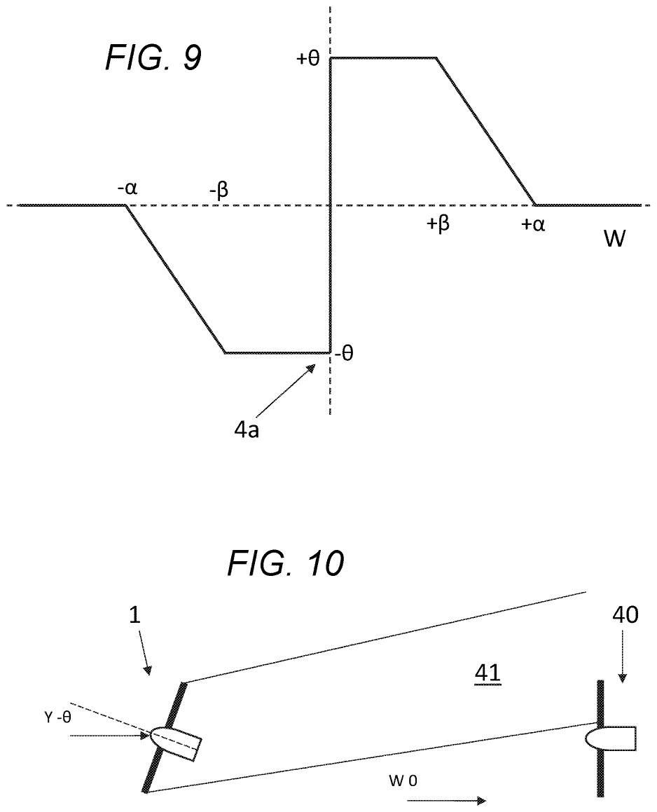

Next the transfer function has a step transition where it jumps from point 3a to point 4a indicated in FIG. 9. The yaw offset signal 32 jumps to a minimum angle −θ, so the rotor axis is at an angle −θ to the wind direction as shown in FIG. 10. At point 4a, the wake 41 may affect the second wind turbine 40 as shown in FIG. 10.

The remaining parts of the transfer function of FIG. 3 will not be described, since the transfer function is symmetrical.

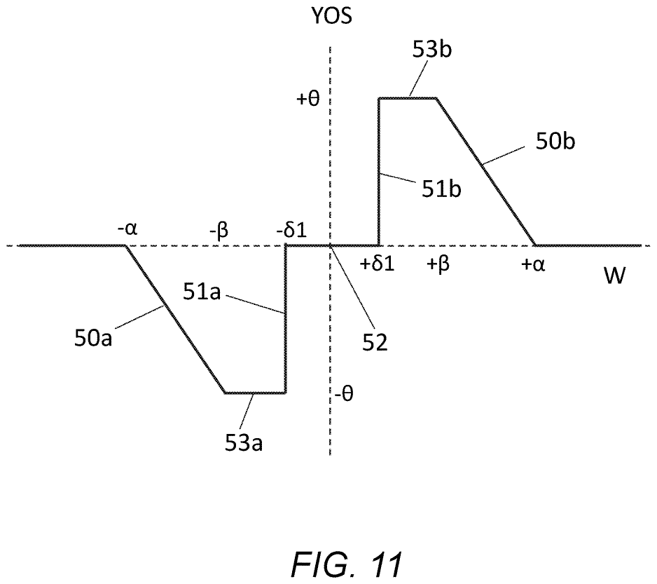

In an embodiment of the present invention, the yaw offset signal 32 may be varied on the basis of a transfer function shown in FIG. 11, which is stored in a memory of the yaw offset controller 30 in the form of a look up table or in any other way.

The transfer function of FIG. 11 comprises various bands (that is, parts of the transfer function which span a range of wind directions) and two step transitions (that is, parts of the transfer function which do not span a range of wind directions). Specifically, the transfer function comprises: a negative offset band 50a in which the yaw offset signal is negative, and decreases to a minimum of −θ as a magnitude of the wind direction decreases (i.e. as the wind direction becomes more closely aligned to the full-wake wind direction); a negative step transition 51a in which the yaw offset signal increases from the minimum; a positive offset band 50b in which the yaw offset signal is positive, and increases to a maximum of +θ as a magnitude of the wind direction decreases (i.e. as the wind direction becomes more closely aligned to the full-wake wind direction); a positive step transition 51b in which the yaw offset signal decreases from the maximum; and a dead band 52 between the positive and negative step transitions.

The yaw offset signal may be lower than the maximum +θ throughout the dead band 52 and higher than the minimum −θ throughout the dead band 52.

A negative cut-out band 53a may be provided between the negative offset band 50a and the negative transition 51a. The yaw offset signal may be substantially equal to the minimum of −θ throughout the negative offset cut-out band 53a.

Similarly a positive cut-out band 53b may be provided between the positive offset band 50b and the positive transition 51b. The yaw offset signal may be substantially equal to the maximum of +θ throughout the positive offset cut-out band 53b.

The cut-out bands 53a, 53b avoid an excessive amount of yaw offset being applied.

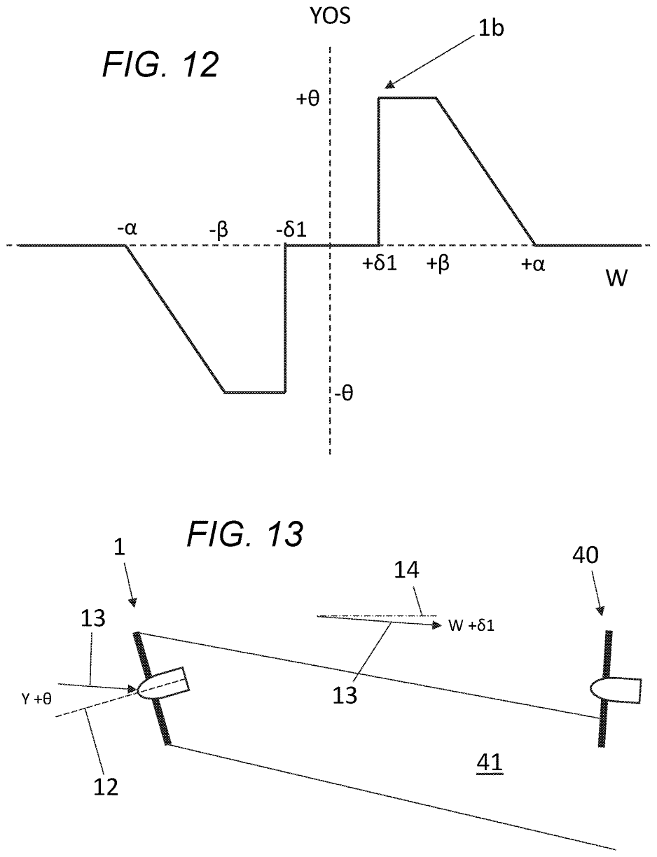

The transfer function of FIG. 11 is identical to the transfer function of FIG. 3, except for the presence of the dead band 52. FIG. 12 indicates a first point 1b at the upper end of the dead band 52. For this wind direction +δ1, the yaw offset signal 32 is at the maximum +θ so the rotor axis is at an angle +θ to the wind direction as shown in FIG. 13. At this first point 1b, the wake 41 may affect the second wind turbine 40 as shown in FIG. 13, but to a lesser extent than in FIG. 8.

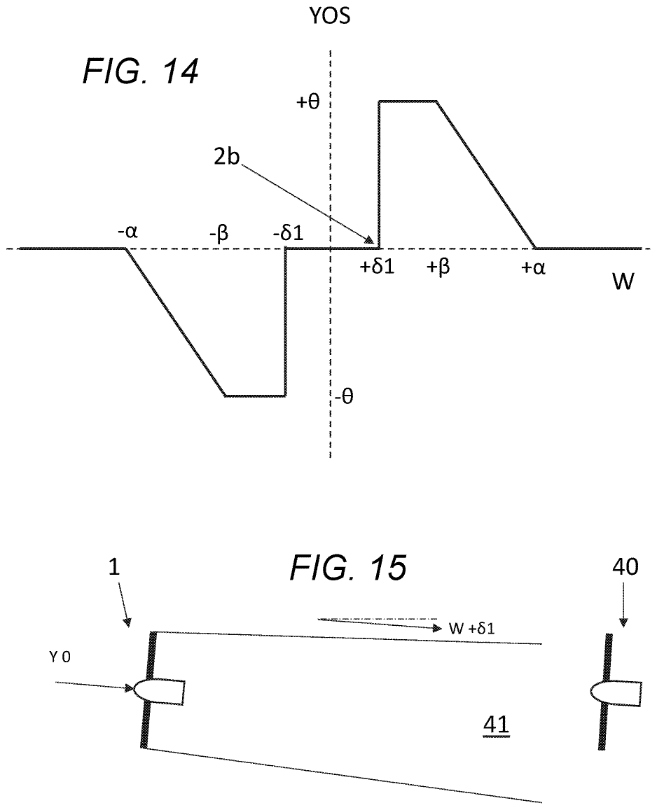

At a second point 2b shown in FIG. 14, the yaw offset signal 32 jumps to zero so there is substantially zero offset between the rotor axis of the first wind turbine 1 and the wind (that is, the rotor axis is parallel to the wind). At the second point 2b, the wake 41 may affect the second wind turbine 40 as shown in FIG. 15.

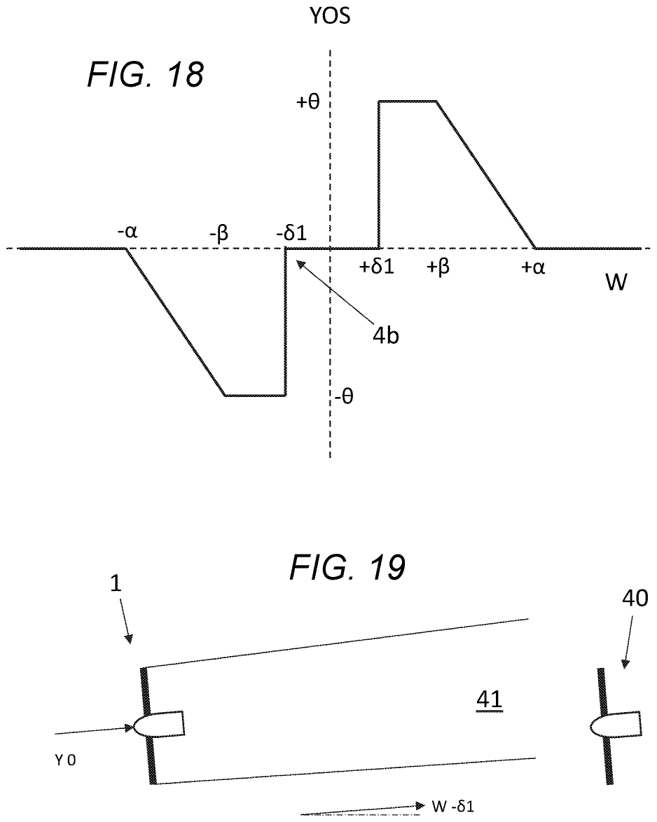

As the wind direction reduces from +δ1, the transfer function is flat until a fourth point 4b shown in FIG. 18. For this part of the transfer function the yaw offset signal 32 remains at zero so the rotor axis is parallel to the wind.

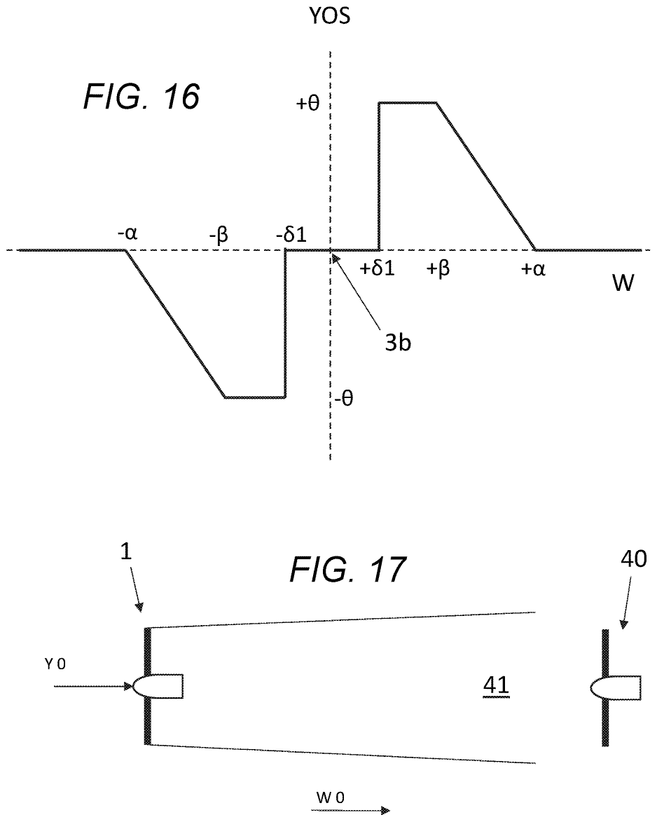

At all points in the dead band 52, the wake 41 may affect the second wind turbine 40, especially at the third point 3b of FIG. 16 which is associated with the “full wake” operating state of FIG. 17 in which the second wind turbine 40 is directly downwind of the first wind turbine 1.

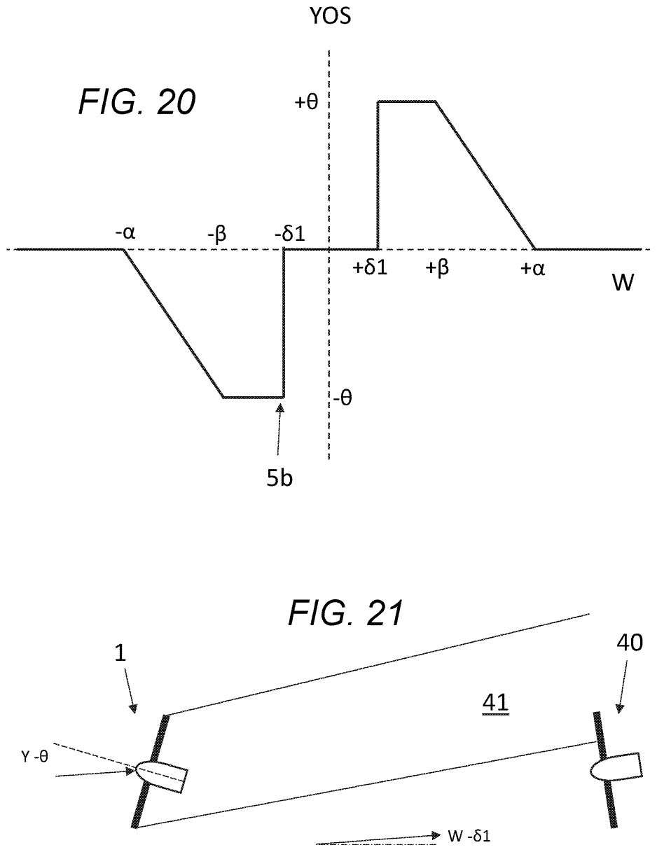

When the wind direction reaches −δ1, the transfer function takes a step down to the minimum −θ at a fifth point 5b indicated in FIG. 20, so the wake 41 is steered away from the second wind turbine 40 as shown in FIG. 21.

For wind directions less than −δ1 the transfer function of FIG. 11 is identical to the transfer function of FIG. 3, so these parts of the transfer function will not be described again.

The transfer functions described herein are based on a sign-convention in which counter-clockwise is defined as the positive direction for the yaw offset, and clockwise is defined as the positive direction for the wind direction. Hence in FIG. 13, for example, the rotor axis 12 is rotated counter-clockwise relative to the wind 13 to give a positive yaw offset angle of +θ; and the wind 13 is rotated clockwise relative to the heading 14 to give a positive wind direction +δ1. Other embodiments of the present invention may use different sign-conventions.

Returning to FIG. 11, the dead band 52 provides an inflection region in the transfer function, similar to a point of inflection in a smooth curve, where a rate of change of the transfer function decreases at the lower boundary of the dead band then increases at the upper boundary of the dead band. This inflection region breaks up the large step transition between points 3a and 4a of the exemplary transfer function of FIG. 3.

The rate of change is greater in the step transitions 51a, 51b than in the dead band 52. For example the rate of change may be very large (or infinite) in the step transitions 51a, 51b and substantially zero in all or part of the dead band 52.

When the yaw offset signal is zero in the dead band 52, there is substantially zero offset between the rotor axis of the first wind turbine and the wind direction as shown in FIGS. 15, 17 and 19, and hence the wake 41 is not steered away from the second wind turbine 40. As a result, the wake 41 may affect the second wind turbine when the first wind turbine 1 is operating in the dead band 52. To mitigate this affect, the control system 20 may apply induction control to the first wind turbine 1 in response to the wind turbine entering the dead band 52. This induction control may cause the effect of the wake 41 to reduce and remain relatively low in all or part of the dead band 52.

The induction control may comprise changing a pitch angle of one or more blades 5 of the rotor 4 via the pitch reference signal 27, changing the power via the power reference signal 26, chancing the tip speed ratio, or any other form of induction control.

Such induction control may provide both a net power gain and a load relieving effect, or may at least reduce the combined power loss from the affected turbines at the gain of the load relieving effect.

The transfer function of FIG. 11 may be fixed, or it may be varied during operation of the wind turbine 1. For example, the yaw offset controller 30 optionally monitors a wind variability condition and varies a width of the dead band on a basis of the wind variability condition. This wind variability condition may comprise an atmospheric stability, a wind direction variability, a turbulence intensity, or any other indicator of wind variability. A low wind variability (associated with a high atmospheric stability, a low wind direction variability or a low turbulence intensity) may cause the yaw offset controller 30 to make the dead band narrower.

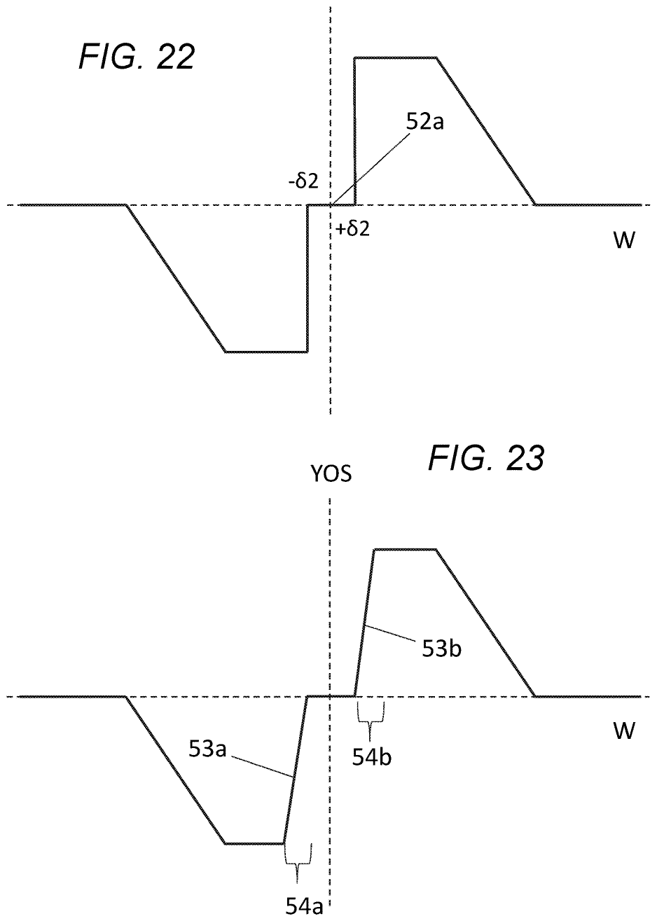

FIG. 22 gives an example of a transfer function in which the width of the dead band is reduced from the dead band 52 spanning a relatively large range of wind directions (−δ1 to +δ1) to a narrower dead band 52a spanning a smaller range of wind directions (−δ2 to +δ2).

The transitions 51a, 51b in the transfer function of FIG. 11 are step transitions which do not span a range of wind directions, but FIG. 23 gives an alternative example in which each transition comprises a transition band 53a, 53b spanning a range of wind directions 54a, 54b, so the change is more gradual. The rate of change of the yaw offset signal in each transition band 53a, 53b is relatively large (compared with the dead band) but lower than in the step transitions 51a, 51b of FIG. 11.

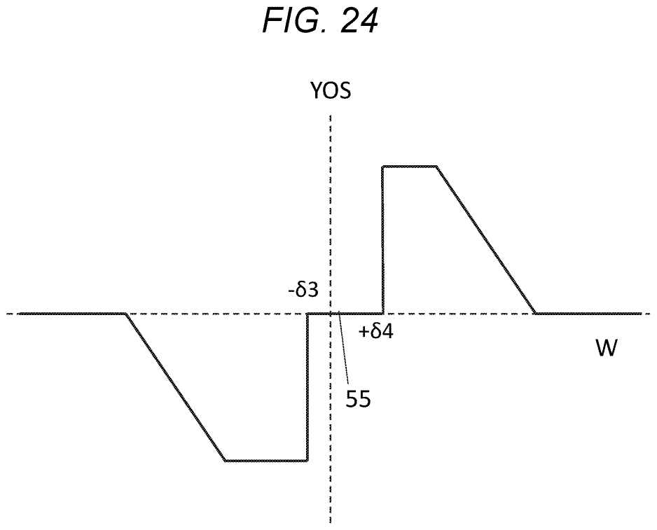

The dead band may straddle the full-wake wind direction. In the case of FIG. 11, the dead band 52 straddles the full-wake wind direction symmetrically, with the same range of dead band on one side of the full-wake wind direction as on the other side. The alternative dead band 55 of FIG. 24 straddles the full-wake wind direction asymmetrically, with the range of the dead band 55 being larger on one side of the full-wake wind direction than on the other. In other words, the centre of the dead band 55 is offset from the full-wake position.

In this example the dead band 55 spans a range of wind directions from −δ3 to +δ4, where |δ4|>|δ3|. Hence the range |δ4| of the dead band 55 on the positive side of the full-wake wind direction is larger than the range |δ3| of the dead band 55 on the negative side of the full-wake wind direction.

Such an offset dead band can be used to balance the loads with the power gain from wake steering. For example, if loads at negative yaw offsets are more favorable than at positive yaw offsets, it may be beneficial to have more of the dead band on the positive side to help reduce loads, as in the example of FIG. 24.

Advantages of a dead band will now be described.

As explained above, the transfer function of FIG. 3 has a step transition where it jumps from point 3a to point 4a, changing by an angle of 2θ which may be of the order of 40 deg. The large size of this step transition can cause wear of the yaw control system 31, particularly if the wind direction is switching back-and-forth rapidly across the full-wake wind direction. One advantage of all of the dead bands described above in FIGS. 11-24 is that they reduce the size of the transition (halving its size from 2θ to θ) resulting in less wear to the yaw control system 31.

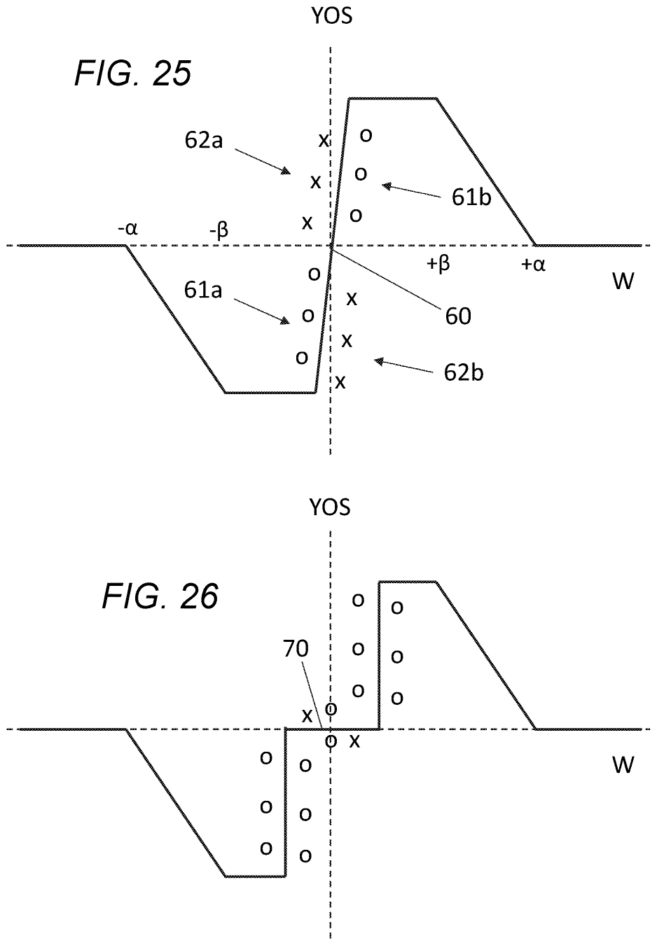

Another advantage of a dead band will be explained with reference to an alternative transfer function shown in FIG. 25, which has no dead band. If the wind direction is switching back-and-forth rapidly across the full-wake wind direction, then the step transition of FIG. 3 will cause the yaw offset signal to switch rapidly back-and-forth. The transfer function of FIG. 25 has a single transition band 60 which is more gradual, spanning a range of wind directions and thus avoiding the problem of rapid back-and-forth switching of the yaw offset signal.

Although the yaw control system 31 ideally precisely follows the transfer function of FIG. 25, the actual yaw offset of the rotor axis will adopt a stochastic range of operating states centred on the transfer function, indicated by crosses and circles in FIG. 25.

Some of these operating states comprise negative yaw offsets associated with negative wind directions (indicated by circles 61a in the bottom-left quadrant of FIG. 25) and positive yaw offsets associated with positive wind directions (indicated by circles 61b in the top-right quadrant of FIG. 25). These are acceptable operating states because they result in a steering of the wake away from the second wind turbine 40.

Other operating states comprise positive yaw offsets associated with negative wind directions (indicated by crosses 62a in the top-left quadrant of FIG. 25) and negative yaw offsets associated with positive wind directions (indicated by crosses 62b in the bottom-right quadrant of FIG. 25). These are less acceptable operating states because they result in a steering of the wake towards the second wind turbine 40, potentially resulting in a net power loss.

FIG. 26 shows operating states associated with a transfer function which includes a dead band 70 in accordance with an embodiment of the present invention. As with FIG. 25, the actual yaw offset of the rotor axis will adopt operating states centred on the transfer function, indicated by crosses and circles in FIG. 26.

In this case there are fewer of the less acceptable operating states in the top-left and bottom-right quadrants (as indicated by the crosses in FIG. 26) and any such operating states have a relatively low yaw offset angle.

In the embodiments of the invention described above, the transfer function may be stored at the wind turbine 1 in a memory of the yaw offset controller 30. In other embodiments of the invention the transfer function may be stored remotely from the wind turbine 1, for instance at a centralised location.

In the embodiments of the invention described above, the transfer function may be stored in in the form of a look up table, either at the wind turbine 1 or at a centralised location. In other embodiments of the invention, the transfer function may be obtained by an online optimization or similar.

Although the invention has been described above with reference to one or more preferred embodiments, it will be appreciated that various changes or modifications may be made without departing from the scope of the invention as defined in the appended claims.

1. A method of wake steering a first wind turbine, wherein a second wind turbine is positioned downstream of the first wind turbine so that the second wind turbine can be affected by a wake of the first wind turbine, the method comprising:
applying a yaw offset signal to a yaw control system of the first wind turbine, the yaw offset signal causing the yaw control system to create a yaw offset between a rotor of the first wind turbine and a wind direction, the yaw offset steering the wake away from the second wind turbine; and
varying the yaw offset signal in response to changes in the wind direction, wherein the yaw offset signal is varied on the basis of a transfer function, and the transfer function comprises:
a negative offset band in which the yaw offset signal is negative, and decreases to a minimum;
a negative transition in which the yaw offset signal increases from the minimum;
a positive offset band in which the yaw offset signal is positive, and increases to a maximum;
a positive transition in which the yaw offset signal decreases from the maximum; and
a dead band between the positive and negative transitions, the yaw offset signal being substantially zero in at least part of the dead band, so that in at least part of the dead band there is substantially zero offset between the rotor of the first wind turbine and the wind direction.

2. The method according to claim 1, wherein the transfer function has a rate of change which is greater in the transitions than in the dead band.

3. The method according to claim 1, wherein the transfer function has a rate of change which is substantially zero in at least part of the dead band.

4. The method according to claim 1, wherein each transition comprises a transition band which spans a range of wind directions.

5. The method according to claim 1, wherein the yaw offset signal is lower than the maximum throughout the dead band and higher than the minimum throughout the dead band.

6. The method according to claim 1, further comprising monitoring a wind variability condition, and varying a width of the dead band on a basis of the wind variability condition.

7. The method according to claim 1, wherein the wake affects the second wind turbine when the first wind turbine is operating in the dead band.

8. The method according to claim 1, wherein the dead band straddles a full-wake direction, wherein the full-wake direction is parallel with a heading between the first and second wind turbines.

9. The method according to claim 8, wherein the dead band straddles the full-wake direction asymmetrically, with a range of the dead band being larger on one side of the full-wake direction than on the other side of the full-wake direction.

10. The method according to claim 1, further comprising applying induction control to the first wind turbine in response to the wind turbine entering the dead band, wherein applying the induction control causes the wake to reduce.

11. The method according to claim 10, wherein applying the induction control comprises changing at least one of a pitch angle of one or more blades of the rotor and a tip speed ratio.

12. The method according to claim 1, wherein the transfer function further comprises: a negative cut-out band between the negative offset band and the negative transition, wherein the yaw offset signal is substantially equal to the minimum throughout the negative offset cut-out band; and a positive cut-out band between the positive offset band and the positive transition, wherein the yaw offset signal is substantially equal to the maximum throughout the positive cut-out band.

13. A yaw offset controller configured to control a first wind turbine by a method according to claim 1.

14. A wind turbine comprising: a rotor; a yaw control system; and a yaw offset controller according to claim 13.
